(19) United States
(12) Patent Application Publication
(10) Pub. No.: US 2018/0324389 A1
(43) Pub. Date: Nov. 8, 2018

(54) Surveillance Camera Platform

(71) Applicant: Frederick Rommel Cooke, Los Angeles, CA (US)

(72) Inventor: Frederick Rommel Cooke, Los Angeles, CA (US)

(21) Appl. No.: 15/969,377

(22) Filed: May 2, 2018

Related U.S. Application Data
(60) Provisional application No. 62/500,211, filed on May 2, 2017.

(51) Int. Cl. H04N 7/18; G06T 1/00; H04N 5/247; G06K 9/00; H04N 5/33; G03B 17/56

(52) U.S. Cl. CPC H04N 7/181; G06T 1/0007; H04N 5/247; G03B 2217/007; H04N 5/33; G03B 17/56; G06K 9/00771

(57) ABSTRACT

The present disclosure is directed to a monitoring system that includes multiple rotatable camera systems, a solar panel, and transceiver.

### TECHNICAL FIELD

This invention relates to surveillance, and more particularly to surveillance camera platform.

### BACKGROUND

Thousands of children go missing each year. In some cases, these missing children have been kidnapped. Predators generally watch for children with distracted parents (e.g., smartphones) and when separated from them (e.g., across the park). An abduction can take a few seconds. These predators fear images of their faces, license plates, and/or activities. The greatest help to law enforcement are eyewitnesses and images of the individuals and what they have done.

### SUMMARY

This disclosure is directed to installing surveillance cameras in parks, playgrounds, and schools to protect against pedophiles and other predators. In some instances, high-definition cameras (e.g., four) with night vision can be used to capture images that are then run through a facial-recognition program. For example, law enforcement can upload captured images to US Department of Justice NGI database. In some examples, the four cameras are concealed in a five inch diameter acrylic tube. The tube can be made to appear as a cell phone transmitter, or a high voltage transformer. In a playground setting, it can be disguised as a miniature rocket. In anyone of the images just mentioned, a predator or criminal may not recognize the tube to be a surveillance camera platform. In some implementations, the camera system has a 360° viewing angle and can be installed, for example, at park entrances, restrooms, and play areas. Once captured, the images can be remotely stored. In addition to the camera system, signs can be posted in the area that state, for example, “Police Cameras in use 24 hours a day with night vision—WE SEE EVERYTHING ALL THE TIME.” In some implementations, the camera system includes a wireless transmission unit that allow law enforcement to view the captured images. This platform is not only designed to protect children from predators, but it can also be used in wild animal game reserves to protect endangered animals from poachers

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an example capture system in accordance with some implementations of the present disclosure.

FIG. 2 is an example camera system that in accordance with some implementations of the present disclosure.

FIG. 3 is a flowchart of an example method for capturing images in accordance with some implementations of the present disclosure.

FIG. 4 is an example camera system that in accordance with some implementations of the present disclosure.

Like reference symbols in the various drawings indicate like elements.

### DETAILED DESCRIPTION

The present disclosure is directed to a system and method for capturing images, storing captured images, and providing the capture images to law enforcement upon request. Not only can the capturing system assist in identifying criminals and criminal activity, the capturing system can also act as a deterrent for future criminal activity especially if the potential criminals are aware of the capturing system.

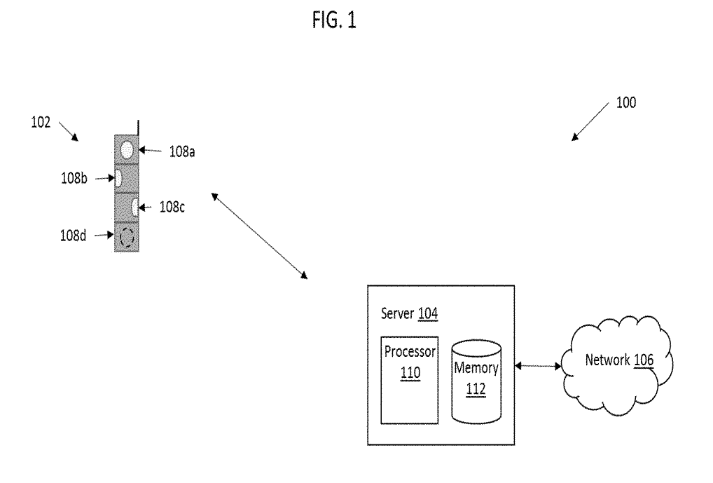

FIG. 1 illustrates an example capturing system 100 for capturing, storing, and retrieving images in accordance with some implementations of the present disclosure. For example, the capturing system 100 may be able to capture images in 360°. In the illustrated example, the capturing system 100 includes a camera system 102 communicably couple to a server 104 through, for example, a wireless connection. A wired connection can be used without departing from the scope of the disclosure. In the illustrated implementation, the server 104 is also communicably couple to a network 106 where the server may receive image requests from and transmit images to law enforcement.

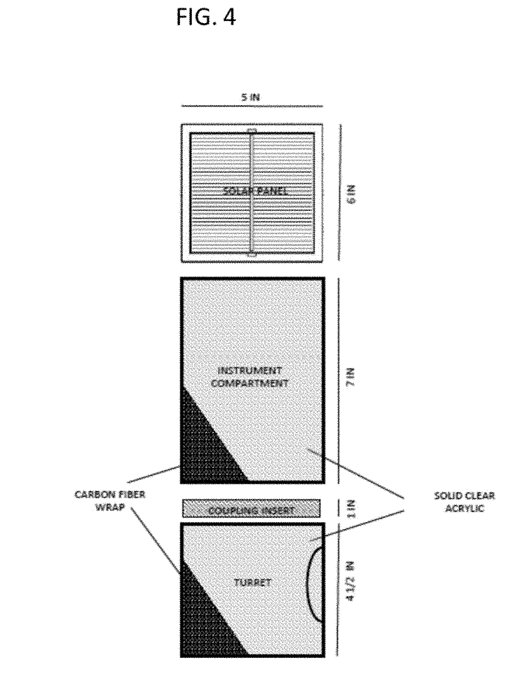

The camera system 102 can be any software, hardware, firmware, or a combination thereof configured to capture images and wirelessly transmit the capture images to the server 104. As illustrated, the camera system 102 includes turret cameras 108a-d. Each turret camera 108 rotatable about a central axis, so the field of views of the camera system 102 are adjustable. In some implementations, the turret cameras 108a-d are cylindrical and connected using a rotatable connection. For example, the turret cameras 108a-d may be connected using couplers. For example, the four cameras can be attached to independent 5 inch diameter by 4½ inch long acrylic turrets (See FIG. 4). The 5 inch turrets are connected to each other by one inch internal couplers. In these instances, the 4 cameras are connected to the transmitter by a 30 inch multi hardwire harness. In these implementations, axis of rotation of the turret cameras 108a-d can be aligned. Other connections can be used without departing from the scope of the disclosure. The turret cameras 108a-d can have a housing made from metal (e.g., aluminum), plastic, other materials, or a combination thereof. In some implementations, the turret cameras 108a-d include windows transparent to the portion of the spectrum detectable by the camera sensors (e.g., visible light, infrared). The transparent windows can be made from glass, plastic, or other materials without departing from the scope of the disclosure. The entire platform can be made from a solid tube of clear acrylic and wrapped in carbon fiber. What appears to be a lens hole can be a 55 mm round hole cut in the carbon fiber wrap (See FIG. 4).

The server 104 is a high-level architecture block diagram coupled with a network 106, according to an implementation. The described illustration is only one possible implementation of the described subject matter and is not intended to limit the disclosure to the single described implementation. Those of ordinary skill in the art will appreciate the fact that the described components can be connected, combined, or used in alternative ways, consistent with this disclosure.

The network 106 facilitates communications between the server 104 and other devices. The network 106 can be a wireless or a wireline network, a memory pipe, a hardware connection, or any internal or external communication paths between the components.

The server 104 includes a computing system configured to perform the algorithm described in this disclosure to process resource requests. In some cases, the algorithm can be implemented in an executable computing code, e.g., C/C++ executable codes. Alternatively, or in combination, the algorithm can be implemented in an application program, e.g., EXCEL. In some cases, the server 104 can include a standalone Linux system that runs batch applications. In some cases, the server 104 can include mobile or personal computers that run the application program.

The server 104 may include an input device, such as a keypad, keyboard, touch screen, microphone, speech recognition device, or another device that can accept user information, and/or an output device that conveys information associated with the operation of the server 104, including digital data, visual and/or audio information, or a GUI.

The server 104 can serve as a client, network component, a server, a database or other persistency, or the like. In some implementations, one or more components of the server 104 may be configured to operate within a cloud-computing-based environment.

At a high level, the server 104 is an electronic computing device operable to receive, transmit, process, store, or manage data and information. According to some implementations, the server 104 may also include or be communicably coupled with an application server, e-mail server, web server, caching server, streaming data server, business intelligence (BI) server, and/or other server.

The server 104 can receive requests over network 106 from a client application (e.g., executing on a user device) and respond to the received requests by processing said requests in an appropriate software application. In addition, requests may also be sent to the server 104 from internal users (e.g., from a command console or by another appropriate access method), external or third parties, other automated applications, as well as any other appropriate entities, individuals, systems, or computers.

The server 104 includes a processor 110. Although illustrated as a single processor 110, two or more processors may be used according to particular needs, configurations, or particular implementations of the server 104. Generally, the processor 110 executes instructions and manipulates data to perform the operations of the server 104. In some cases, the processor 110 can include a data processing apparatus.

The server 104 also includes a memory 112 that stores images for the server 104. Although illustrated as a single memory 112, two or more memories may be used according to particular needs, configurations, or particular implementations of the server 104. While memory 112 is illustrated as an integral component of the server 104, in alternative implementations, memory 306 can be external to the server 104.

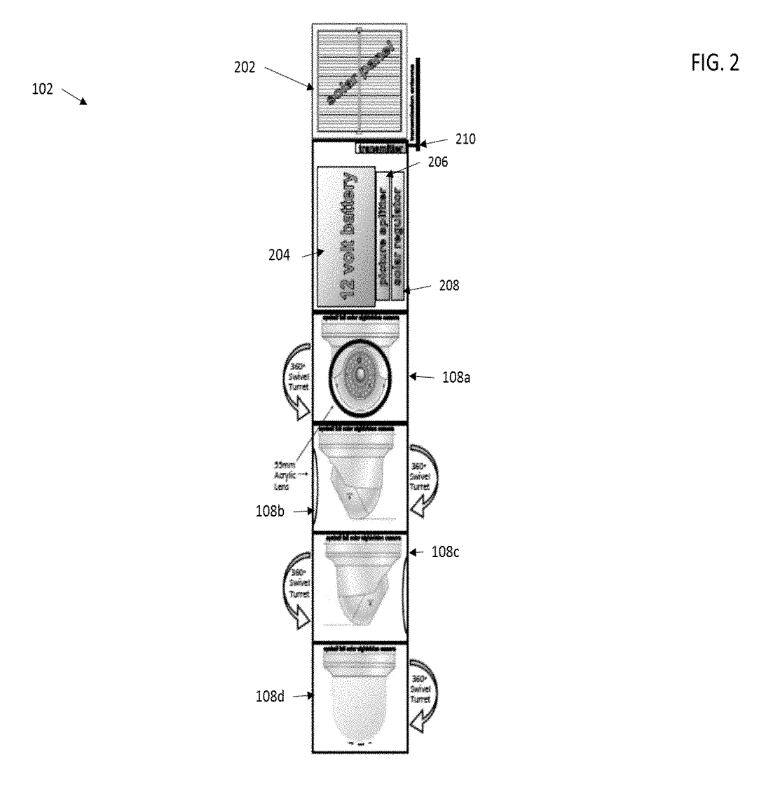

FIG. 2 is an example camera system 102 in accordance with some implementations of the present disclosure. As illustrated, each turret camera 108 can rotate 360° and has cylindrical housing. In addition, the camera system 102 includes a solar panel 202 to allow for operation off the electrical grid. In addition, the camera system 102 includes a battery 204 (e.g., 12-volt battery) for storing the power and a solar regulator 208 for regulating the operation of the solar panel 202. The regulator 208 controls the amount of electrical current that goes into the battery, it prevents or reduces the likelihood that the solar panel from over loading the battery. The picture splitter 206 is configured to sends all camera pictures to a monitor or receiver in one split picture frame. In the illustrated implementation, the camera system 102 includes a transmitter 210 for wirelessly transmitting capture images to, for example, the server 104. As previously mentioned, local law enforcement may access the stream of images using, for example, a smart phone. In doing so, local law enforcement may be able to monitor areas in real time.

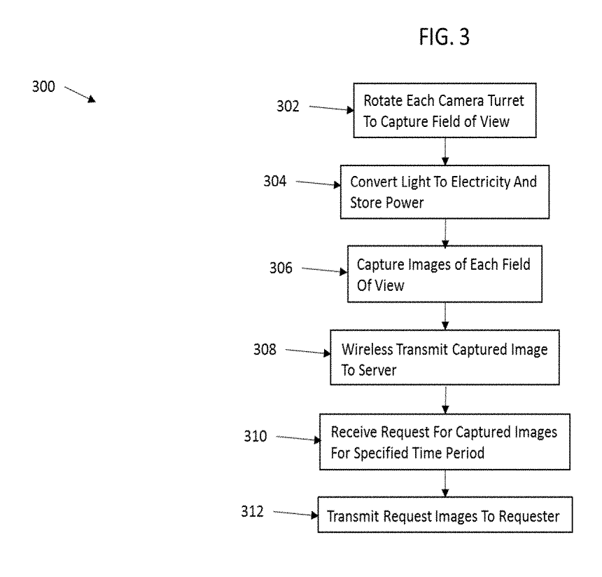

FIG. 3 is a flow diagram showing an example method 300 for capturing images, according to an implementation. The method 300 can be implemented by the entities shown in FIG. 1, including, for example, the vehicular security server camera system 102. The method 300 shown in FIG. 3 can also be implemented using additional, fewer, or different entities. Furthermore, the method 300 shown in FIG. 3 can be implemented using additional, fewer, or different operations, which can be performed in the order shown or in a different order. In some instances, an operation or a group of operations can be iterated or repeated, for example, for a specified number of iterations or until a terminating condition is reached.

At step 302, each turret camera is rotated to a capture a corresponding field of view. For example, each of the turret cameras 108 can be rotated to have field of views that are overlapping, non-overlapping, or a combination thereof. Next, at step 304, incident light is converted to electricity and stored. In the example, the solar panels 202 in FIG. 2 can convert incident sunlight into electricity and store the corresponding power in the battery 204. Images of each field of view is captured at step 306. Again in the example, each of the turret cameras 108 captures the corresponding field of view. At step 308, the captured images are wireless transmitted to a server for storage. Returning to the example, the camera system 102 wireless transmits the captured images to the server 104. Next, at step 310, a request is received for captured images for a specified time period. In the example, the sever 104 may receive a request through the network 106 from law enforcement. At step 312, the requested images are transmitted. As for the example, the server 104 can transmit the requested images through the network 106.

A number of embodiments of the invention have been described. Nevertheless, it will be understood that various modifications may be made without departing from the spirit and scope of the invention. Accordingly, other embodiments are within the scope of the following claims.

What is claimed is:

1. A monitoring system, comprising:
an imaging system, comprising:
a plurality of camera turrets, each of the plurality of camera turrets enclosing a camera, connected to at least one adjacent camera turrent, and rotatable around a central axis of the monitoring system;
a solar panel configured to convert sunlight to electricity;
a battery connected to the solar panel and each camera and configured to store power; and
a wireless transceiver connected to the battery and configured to wireless communicated with a remote server.

2. The monitoring system of claim 1, wherein each of the plurality of turrets are cylindrical and have a central axis aligned with the central axis of the monitoring system.

3. The monitoring system of claim 1, wherein each camera captures infrared images.

4. The monitoring system of claim 1, wherein the plurality of camera turrets are rotatable to a configuration where each camera has a different field of view.

5. The monitoring system, wherein the wireless transceiver comprising a first wireless transceiver, further comprising:
the remote server, comprising:
a second wireless transceiver configured to wireless communicate with the first wireless transceiver of the imaging system; and
memory configured to store images and associated timestamps received from the imaging system.
